(19) United States
(12) Patent Application Publication
(10) Pub. No.: US 2025/0371265 A1
(43) Pub. Date: Dec. 4, 2025

(54) SYSTEM AND METHOD FOR ANNOTATION-GUIDED DOCUMENT SUMMARIZATION THROUGH GENERATIVE ARTIFICIAL INTELLIGENCE

(71) Applicant: MH SUB I, LLC, El Segundo, CA (US)

(72) Inventors: Daniela Ovadia, Milan (IT); Franklin Tseng, El Segundo, CA (US)

(21) Appl. No.: 18/760,981

(22) Filed: Jul. 1, 2024

Related U.S. Application Data
(60) Provisional application No. 63/655,514, filed on Jun. 3, 2024.

(51) Int. Cl. G06F 40/205; G06F 40/169

(52) U.S. Cl. CPC G06F 40/205; G06F 40/169

(57) ABSTRACT

A computing device operating with generative artificial intelligence (AI) logic for condensing content of a document to produce a summary is described. The computing device features at least a processor and a non-transitory storage medium coupled to the processor. The non-transitory storage medium includes an AI summarization workflow software tool that, when executed, is configured to identify and extract annotations associated with a document, generate a prompt including the annotations and content associated with the document, and output the prompt to generative AI logic to enable generation of at least a summary of the document based on the annotations.

### CROSS-REFERENCE TO RELATED APPLICATIONS

This application claims the benefit of priority on U.S. Provisional Application No. 63/655,514 filed Jun. 3, 2024, the entire contents of which are incorporated by reference herein.

### FIELD

Embodiments of the disclosure relate to the field of artificial intelligence (AI) platform utilization. More specifically, one aspect of the disclosure relates to a system and method that utilizes generative AI logic to perform content summarization based, at least in part, on annotations pertaining to the content.

### GENERAL BACKGROUND

Generative AI technology has been recently deployed as an intelligent agent to conduct conversations with human users. For example, large language models (LLMs) such as ChatGPT for example, have provided a conversational artificial intelligence (AI) platform to perform natural language processing (NLP) tasks. Recently, organizations are beginning to submit documents directly to LLMs and instructing them to generate an output that describes content of the document in a more concise format (hereinafter, a “summary”). However, summaries currently produced by LLMs have experienced quality problems such as inaccuracies and/or misguided focus, as highly relevant content can be mistakenly excluded from the summary. Experimenting with different LLMs and adjusting the prompts submitted to the LLMs, which is extremely labor intensive, have not resolved the quality problems on a consistent basis.

Additionally, reviewers of the summary have noticed that the focus, tone, and writing style applied to a specific summary tend to be influenced by a variety of factors such as the topic of the article, gathered background information, and the targeted readers. For example, when relying on the same content within a document, generative AI logic may generate one summary that focuses on the quantitative details of a clinical study while, at another time, generate a summary that focuses on societal implications. Currently, LLMs have been unable to initially determine which style, tone, and writing style would be most effective in generating an output (e.g., a summary). Instead, there is a substantial reliance on a reviewer to, in some cases, substantially rewrite the summary to better appeal to the targeted readers. Again, this process is time intensive and precludes a company's ability to scale in content generation and delivery.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is an exemplary block diagram of a generative artificial intelligence (AI) summarization platform including an AI summarization workflow tool interacting with cloud services.

FIG. 2A is a first exemplary embodiment of a graphic user interface (GUI) associated with the AI summarization workflow tool of FIG. 1 for uploading of a document for summarization.

FIG. 2B is a second exemplary embodiment of a GUI associated with the AI summarization workflow tool of FIG. 1 for uploading of the document for summarization.

FIG. 3 is an exemplary flowchart operability of the AI summarization workflow tool of FIG. 1.

FIG. 4 is an exemplary block diagram of a prompt created by the AI summarization workflow tool for submission to the generative AI logic of FIG. 1.

FIG. 5 is an exemplary block diagram of the data exchange between the AI summarization workflow tool and the generative AI logic of FIG. 1.

FIG. 6A is an exemplary block diagram of operations conducted by the AI summarization workflow tool with feedback logic to further refine a resultant summary based on feedback metrics.

FIG. 6B is a third exemplary embodiment of a GUI associated with the AI summarization workflow tool of FIG. 1 for conducting feedback operability in generating the feedback metrics for return to the generative AI logic for further revisions to the summary.

FIG. 6C is a fourth exemplary embodiment of a GUI associated with the AI summarization workflow tool utilizing feedback logic of FIG. 6A is shown.

FIG. 7 is an exemplary block diagram of the operations of the AI summarization workflow tool of FIG. 1 operating with the generative AI logic to generate multiple summaries with stylistic and thematic differences for concurrent display to the user in which feedback metrics are created by selection of different portions of the summaries for resubmission as a prompt to generate further summaries directed to the focus, tone and writing style of the user.

FIG. 8A is an exemplary block diagram of the resubmission prompt generated by the AI summarization workflow tool in accordance with the operations of FIG. 7.

FIG. 8B is an exemplary block diagram of multiple resubmission prompts generated by the AI summarization workflow tool in accordance with the operations of FIG. 7.

FIG. 9 is an exemplary block diagram of iterative operations performed in accordance with selection of different sections from multiple summaries as provided by a graphic user interface (GUI) associated with the AI summarization workflow tool of FIG. 1.

### DETAILED DESCRIPTION

Various embodiments of the disclosure are directed to an AI summarization workflow software tool that operates in concert with generative AI logic to produce a summary of a document, where the content of the summary is guided by and based on one or more annotations added to the document. The annotation may be in the form of (a) a highlight, comment and/or graphical images physically added as content into the document (e.g., digitized margin notes) and/or (b) content attached to the document such as an audio clip for example. The AI summarization workflow tool is configured to (i) parse the document and identify annotations within and/or attached to the document, (ii) extract the annotations, (iii) optionally rank these annotations based on the importance of their content for inclusion within a summary, and (iv) generate a prompt that causes the generative AI logic to produce a summary or multiple summaries of the content within the document based, at least in part, on the annotations. The annotations significantly influence the content and layout of the summary or summaries.

The below-described AI summarization workflow software tool and its operations provide a practical application through an automated system that leverages annotations, in combination with the content within a document, to generate one or more summaries of the content. Where multiple summaries, the summaries may be configured to vary based on different focus, tone, writing style, and/or theme. The software tool further provides a technological benefit as fewer computing resources and less time would be utilized than if repetitive, manual refinement of the summary is performed.

According to one embodiment of the disclosure, a human reviewer can edit portions of a document with annotations, such as highlighting different content within the document or adding text (e.g., comments, margin notes, etc.). The annotations are intended to (i) identify specific portions of the document that should be considered as content in a generated summary and/or (ii) identify specific portions of the document that should be excluded as content from the generated summary. Additionally, as an optional feature, the type of annotation may be used to establish a suggested order (or ranking) in which content associated with the annotations should be incorporated into a summary. The annotated document is then processed by the AI summarization workflow tool, where the annotations (e.g., text highlights, comments, added text, etc.) are extracted and presented as part of a prompt provided to generative AI logic such as one or more large language models (hereinafter, “LLM(s)”). The annotations are added as a part of a customized prompt, which has been created specifically for this AI summarization process to improve the quality and focus of the summary generated by the LLM, as described below.

According to another embodiment of the disclosure, instead of annotating the document, in response to submission of the document for summarization by the LLM(s), the AI summarization workflow tool may cause a recipient LLM to establish a communication session with the computing device operating as the source for the document submission. The LLM may be configured to pose a series of questions for a human reviewer (or an automated process on the computing device) to answer. The responses to the series of questions may effectively constitute the “annotations” that define important or relevant portions of the document for summarization.

In yet another embodiment of the disclosure, additionally or in the alternative, the AI summarization workflow tool may be configured to generate one or more prompts each may be directed to a different focus, tone, writing style, and/or theme for the entirely of the summary or different sections of the summary (e.g., title, opening paragraph, conclusion, etc.). The prompt(s), when processed by the generative AI logic, result in the generation of multiple summaries for display on an interactive graphical user interface (GUI) and analysis by a reviewer (e.g., an editorial team, editor, etc.). The interactive GUI provides the reviewer with an ability to view multiple summaries that are displayed concurrently (i.e., at least partially overlapping in time) such as a side-by-side display. Each summary (or section of the summary) may be produced with a different focus, tone, writing style, and/or theme to create a robust and engaging reading experience for a specific targeted audience.

Different section(s) within the summaries may be selected by a reviewer to formulate a revised summary, where the selected sections from different summaries may be resubmitted to the generative AI logic to iteratively generate one or more revised summaries taking into account the focus, tone, writing styles, and/or theme of the selected summary sections. The summarization process is completed when all sections from one of the revised summaries is selected by the reviewer. Alternatively, the review may select the different sections of the summary and, in lieu of resubmission to the generative AI logic, the AI summarization workflow tool generates a composite summary with these selected summary sections that can be edited by the reviewer.

### I. Terminology

In the following description, certain terminology is used to describe aspects of the invention. For example, in certain situations, the terms “logic,” “module,” and “element” are representative of hardware, firmware, or software that is configured to perform one or more functions. As hardware, logic (or element or module) may include circuitry having data processing or storage functionality. Examples of such circuitry may include, but are not limited or restricted to, one or more hardware processors (e.g., a microprocessor with one or more processor cores, a digital signal processor, a programmable gate array, a microcontroller, an application specific integrated circuit “ASIC,” etc.), a semiconductor memory, or combinatorial elements.

Alternatively, logic (or element or module) may be software, such as executable code in the form of an executable application, a graphical user interface (GUI), an Application Programming Interface (API), a subroutine, a function, a procedure, an applet, a servlet, a routine, source code, object code, a shared library/dynamic library, or one or more instructions. The software may be stored in any type of a suitable non-transitory storage medium or transitory storage medium (e.g., electrical, optical, acoustical, or other forms of propagated signals such as carrier waves, infrared signals, or digital signals). Examples of the non-transitory storage medium may include, but are not limited or restricted to, a programmable circuit; semiconductor memory; non-persistent storage such as volatile memory (e.g., any type of random access memory “RAM”); or persistent storage such as non-volatile memory (e.g., read-only memory “ROM,” power-backed RAM, flash memory, phase-change memory, etc.), a solid-state drive, hard disk drive, an optical disc drive, or a portable memory device.

A “computing device” may be generally construed as electronics with data processing capability and/or a capability of connecting to any type of network, such as a public network (e.g., Internet), a private network (e.g., a wireless data telecommunication network, a local area network “LAN,” etc.), or a combination of networks. Examples of a computing device may include, but are not limited or restricted to, the following: a server, an endpoint device (e.g., a laptop, a smartphone, a tablet, a desktop computer, a netbook, networked wearable, or any general-purpose or special-purpose, user-controlled electronic device); a mainframe; a router; or the like.

A “document” may be generally construed as a collection of content that may be processed into a summary, where the “summary” refers to a condensed version of document content (i.e., lesser number of characters or storage size as bytes, kilobytes, or megabytes, etc.) that summarizes a document. The terms “significant” and “significantly,” when referenced in connection with the effect or usage of data on an output, signifies that the data will be used and/or will have an impact on that output.

The term “focus” generally pertains to the specific subject or topic that a reviewer emphasizes in their work, namely what the reviewer directs her/his attention towards. The focus can vary depending on the context, genre, and purpose of the writing. For instance, in an argumentative document, the focus might be on presenting a clear thesis and supporting evidence. In contrast, for a descriptive document, the focus could be on vividly portraying sensory details.

The term “tone” may be generally construed as the overall mood or attitude conveyed by the reviewer through his or her word choice. It sets the emotional tone of a summary and influences how readers perceive the content. Examples of different types of tone can be formal or informal, positive or negative, lighthearted or dramatic, or the like.

The term “style” generally encompasses a wide array of writing choices that affect both the form and content of a text. Style may be established through word choice (selected specific words and phrases); sentence structure (how sentences are constructed); sentence length (e.g., the length of sentences from short, concise to long, elaborate); rhetorical techniques (e.g., persuasive or expressive methods typically used such as repetition, parallelism, etc.); and figuration (e.g., use of literary devices such as metaphors, similes, etc.). The style generated by LLMs may emulate persons who provide reviewed material, as training data, to the LLMs.

The term “theme” generally represents the central idea or underlying point in a summary.

A “message” generally refers to information transmitted in one or more electrical signals that collectively represent electrically stored data in a prescribed format. Each message may be in the form of one or more packets, frames, HTTP-based transmissions, or any other series of bits having the prescribed format. The message may include a “prompt,” namely a piece of text or code that serves as input for generative AI logic such as a large language model (LLM) for example. The prompt can be used to generate various types of content, such as text, images, or even code that form a portion of the summary.

The term “computerized” generally represents that any corresponding operations are conducted by hardware in combination with software and/or firmware.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

### I. Generative Artificial Intelligence (AI) Summarization Platform

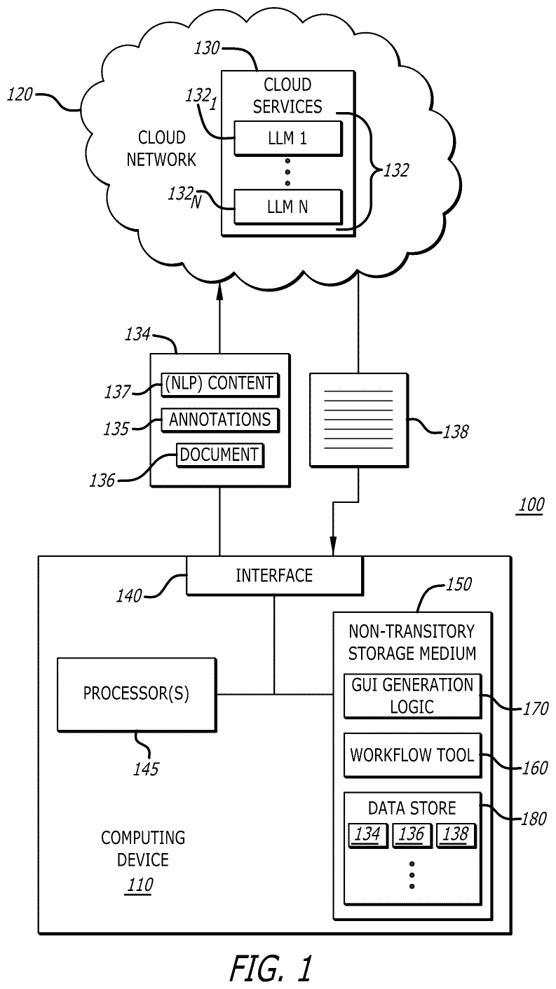

Referring to FIG. 1, an exemplary embodiment of a generative artificial intelligence (AI) summarization platform 100 implemented within a computing device 110 is shown. The AI summarization platform 100 includes an AI summarization workflow software tool 160 which, when in operation, interacts with generative AI logic 132. The generative AI logic 132 may be deployed within cloud services 130 as shown, or as another alternative deployment, the generative AI logic 132 may be deployed as part of on-premises hosted services. The generative AI logic 132 is configured to generate a summary 138 of content within a document 136 selected for summarization. The content of the summary 138 is based, at least in part, on annotations 135 within the document 136 or, although not shown, annotations made within one or more additional documents attached to the prompt 134 such as an attached press release for example.

According to this embodiment of the disclosure, the computing device 110 is communicatively coupled to a cloud network 120, such as a public cloud network or a private cloud network for example, which includes the cloud services 130. Herein, the cloud services 130 may include the generative AI logic 132, such as one or more large language models (LLMs) 132₁-132_{N} (N≥1) for example (hereinafter, “LLM(s) 132”). The LLM(s) 132 are adapted to receive a prompt 134 from the computing device 110 and to return information based on the prompt 134 such as the summary 138. The LLM(s) 132 may constitute a single LLM that is responsible for generating summaries or multiple LLMs, where each LLM 132₁-132_{N} may be configured to handle the task differently, depending on the topic (e.g., genre) of the document 136, geographic region of the document to account for local law or customs, or the like.

For one embodiment of the disclosure, the prompt 134 includes contextual categories that may be used by at least a first LLM (e.g., LLM 132₁) for generating the summary 138 (e.g., a single summary or multiple summaries) of the document 136. Annotations 135 within the document 136 (or attached documents) are extracted and included as part of the prompt 134, where the first LLM 132₁ relies on the annotations 135 to guide or control selection of content within the document 136 that is utilized to generate the summary 138. Stated differently, the annotations 135 influence the focus, tone, writing style, and/or theme of the summary 138 generated by the first LLM 132₁.

As shown in FIG. 1, the computing device 110 features an interface 140, one or more processors 145 (hereinafter, “processor(s)”), and a non-transitory storage medium 150. The interface 140 is adapted to support communications with the cloud network 120. The processor(s) 145 is adapted to execute software associated with the generative AI summarization platform 100, such as the AI summarization workflow software tool 160 as described below.

More specifically, as shown in FIG. 1, the non-transitory storage medium 150 is adapted to store logic and data accessible to the processor(s) 145. The logic may include, but is not limited or restricted to the AI summarization workflow tool 160, graphical user interface (GUI) generation logic 170, and/or a local data store 180 that provides for storage of information such as (i) documents (e.g., document 136), (ii) summaries resulting from such documents (e.g., summary 138), and/or (iii) prompts generated for transmission to the LLM(s) 132 (e.g., prompt 134). The GUI generation logic 170 is configured to generate an interactive screen display (e.g., GUI) for rendering one or more summaries produced by the LLM(s) 132. The data store 180 may operate, at least in part, as a relational database or any other type of storage mechanism to supports correlation between the stored information.

According to one embodiment of the disclosure, the AI summarization workflow tool 160 is configured to generate the prompt 134 to be provided to a destination including the generative AI logic 132, such as the cloud services 130. The prompt 134 includes a set of instructions and/or contextual data provided to the LLM(s) (e.g., LLM 132₁, LLM 132₂, etc.) to cause the LLM(s) 132 to perform one or more tasks. For this example, the task(s) may include the generation of the summary 138 from contextual data included as part of the prompt 134, such as the annotations 135, content associated with the document 136 (e.g., portions of the document 136 or the entire document 136) as well as natural language processing (NLP) content 137 within the prompt 134 in the form of contextual parameters phrased as questions, statements, conditions, examples, or the like.

More specifically, the AI summarization workflow tool 160 is configured to parse the document 136, which is received from an external source and maintained in the data store 180 or uploaded from an external storage via a network interface (e.g., interface 140), to detect any annotations. The annotations 135 may include (i) highlights of text or images within the document 136, (ii) comments inserted into and adjacent to selected text or images within the document 136, (iii) graphical images representing notes within margins of the document 136, and/or (iv) attachments to the document 136 such as an attached or linked audio snippet operating as an annotation. Upon parsing and identifying the annotations 135, the AI summarization workflow tool 160 extracts these annotations 135 for insertion within the prompt 134 as a separate segment of information. Additionally, the content of the document 136 may be provided as another segment of information within the prompt 134.

As an optional feature, the AI summarization workflow tool 160 may be configured to perform a ranking (scoring) of these identified annotations 135. The ranking hierarchy may be based on a prescribed level of importance or usefulness of content associated with each annotation 135 in the development of the summary 138. For example, in the development of the summary 138, content associated with a comment may be assigned a greater ranking (score) than text highlights. This ranking hierarchy may be assigned with a comment having a higher ranking than a text highlight because (i) the comment requires textual input by the reviewer, (ii) the comment may include additional insight by the reviewer, and (iii) placement of the comment within a document is time-intensive suggesting its importance if included in the document 136 selected for summarization. Given the time/effort afforded by the receiver to generate a comment, it should be considered of greater utility than text highlights.

Of course, the AI summarization workflow tool 160 may be configured to perform other ranking schemes for different annotation types. For example, the comment and graphical image (note) may be assigned a higher ranking than text highlight annotations. Alternatively, the text highlight annotation may be assigned a higher ranking than a comment or digital image placed on the document 136. The ranking may be a setting for the AI summarization workflow tool that is placed into a default setting, but may be modified by the reviewer.

Additionally, the AI summarization workflow tool 160 may be configured to conduct ranking operations for annotations of the same type, but different annotation subtypes. As an illustrative example, for the same annotation type (e.g., text highlight within the document 136), a first color highlight (first subtype) may be assigned a different ranking than a second color highlight (second subtype). This increased granularity of annotation rankings increases the likelihood that certain annotations will be relied upon in the generation of the content for the summary 138.

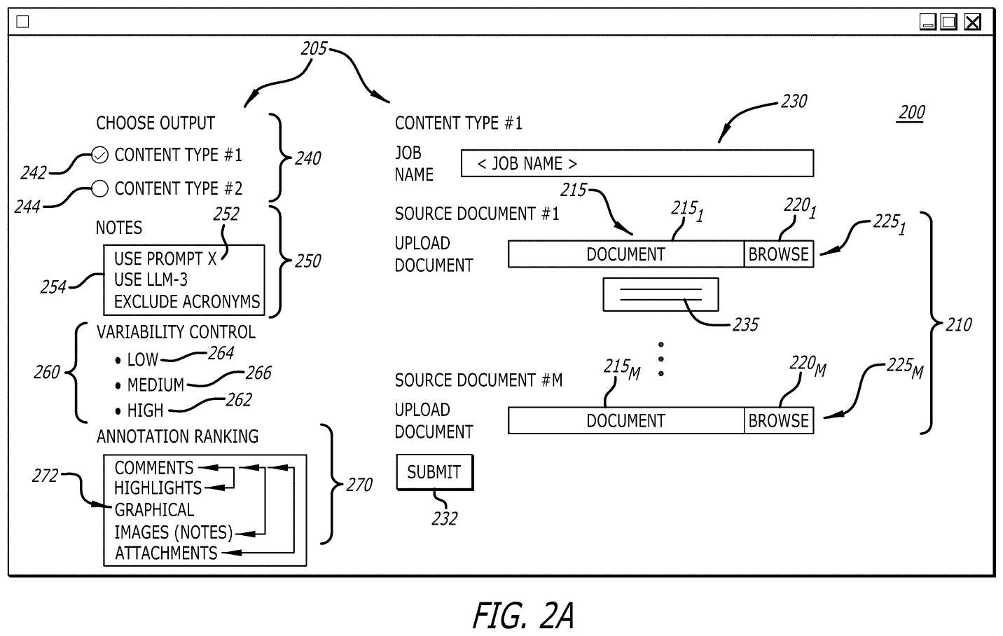

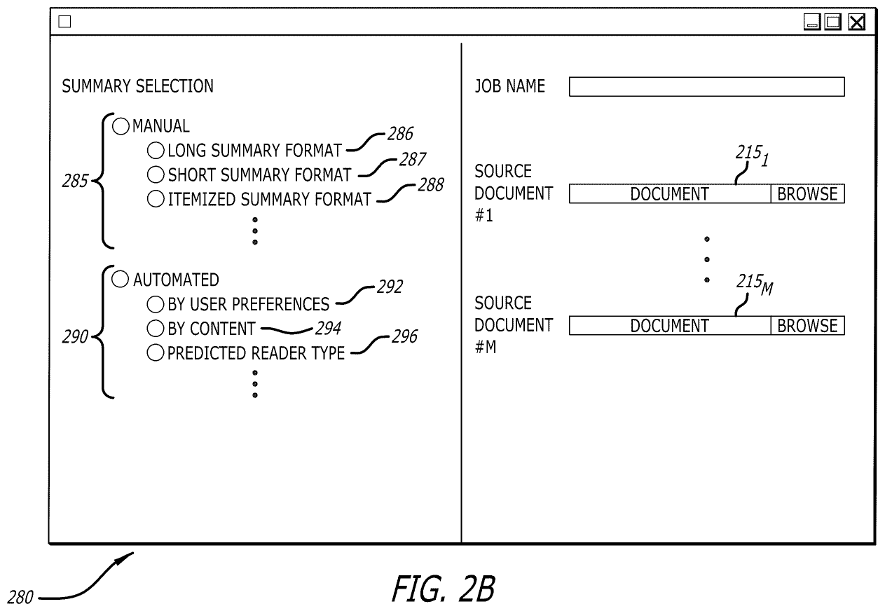

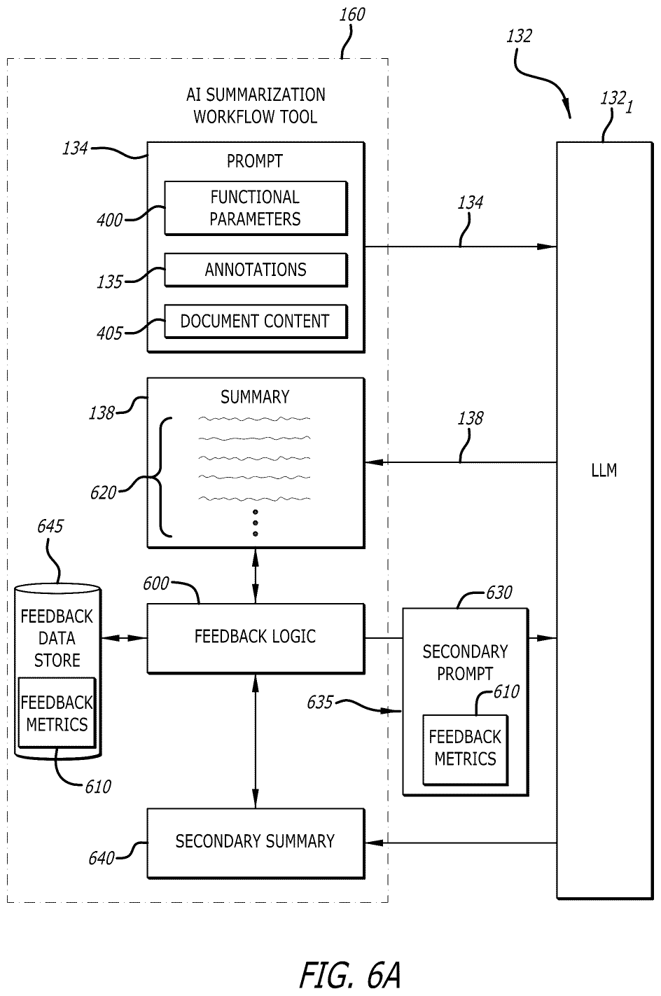

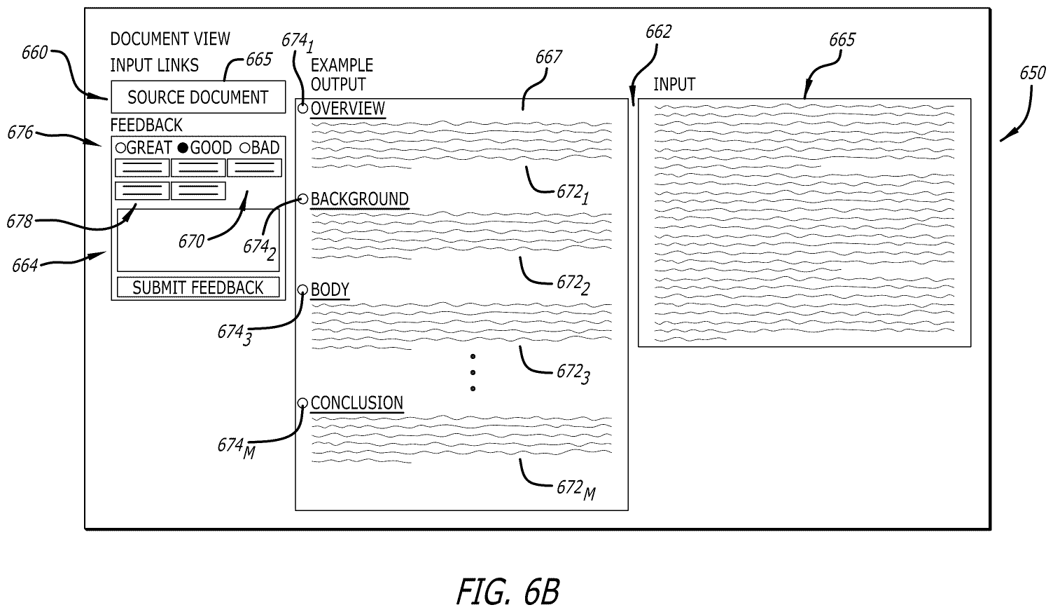

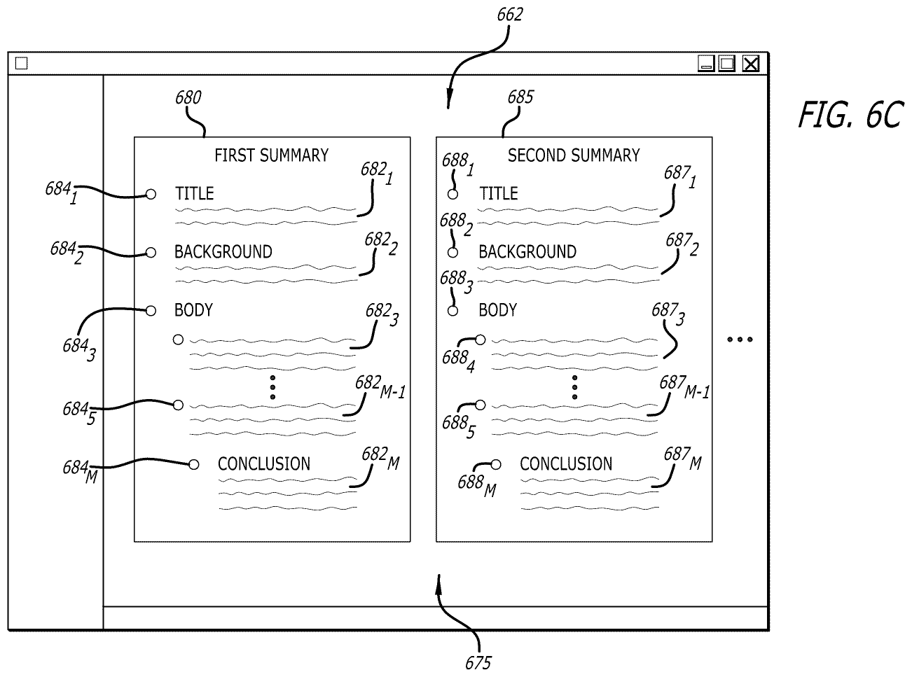

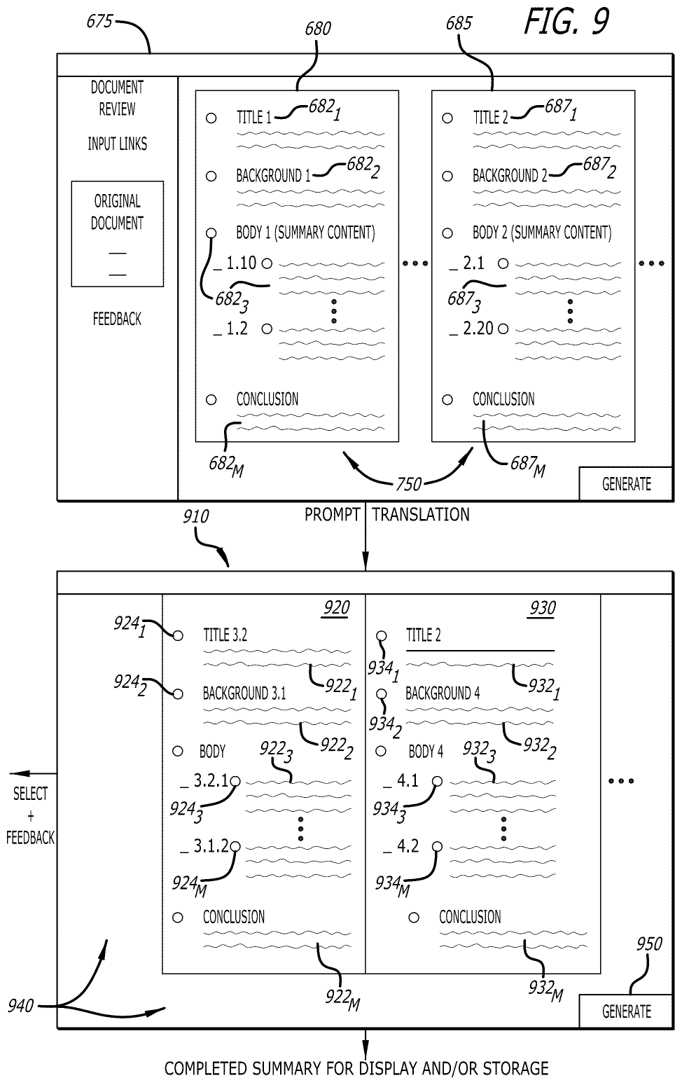

As further shown in FIG. 1, the AI summarization workflow tool 160 provides the prompt 134 to the cloud services 130 for processing by the LLM(s) 132. After transmission of the prompt 134 and return of the summary 138 based on the prompt 134 via the interface 140, the AI summarization workflow tool 160 locally stores content from the summary 138 for access by the GUI generation logic 170. The GUI generation logic 170 is configured to generate a GUI that provides a framework to display one or more summaries accessible by the cloud services 130 for analysis by the reviewer (see FIGS. 6B-6C & FIG. 9). More specifically, the GUI generation logic 170 is configured to generate and cause the rendering of the GUI, which features one or more display elements (e.g., text boxes, radio buttons, pull-down menus, etc.) that, when selected or data entered within the display element(s), may provide additional contextual information included in the prompt 134 provided to the cloud services 130 (see GUI 200 of FIG. 2A). The prompt 134 may further include content of the document 136 and/or its annotations 135.

Referring to FIG. 2A, a first exemplary block diagram of an interactive screen display represented as a graphical user interface (GUI) 200 is shown. The GUI 200 is produced by the GUI generation logic 170 of the AI summarization workflow tool 160 of FIG. 1. In general, the framework of the GUI 200 features a plurality of fields 205 from which content may be used to generate the prompt 134 for submission to the LLM(s) 132 of FIG. 1.

More specifically, the plurality of fields 205 of the GUI 200 includes a first input field 210, which allows for the selection and uploading of one or more documents 215 for summarization, namely “M” source documents 215₁-215_{M}, where M≥1. It is contemplated that the content of the first input field 210 may dynamically change in response to a change of content in a second input field 240. For example, a change in the content type 242 or 244 may result in changes as to which documents 215-215_{M} are available for summarization. As shown, each of the documents 215₁ . . . or 215_{M} may be selected for content analytics (e.g., parsing, etc.) by activation of a “browse” button 220₁ . . . or 220_{M} being part of a corresponding upload field entry 225₁ . . . or 225_{M}. After selection, the content of the selected document 215₁ . . . and/or 215_{M} may be uploaded to the LLM(s) 132 as shown in FIG. 1 as part of the prompt 134 (e.g., a single or multiple prompts).

According to one embodiment of the disclosure, the prompt 134 may be identified by a user-selected label (job name) 230 prior to processing and subsequent submission by the AI summarization workflow tool 160 by selection of a “Submit” button 232. It is noted that the source documents 215₁-215_{M} may include a single source document (e.g., document 215₁) or multiple source documents (e.g., documents 215₁ . . . and 215, where M≥2), generally referred to as “document(s) 215.” The LLM(s) 132 of FIG. 1 will be adapted to conduct analytics on annotations 135 extracted from the document(s) 215, optionally with rankings associated with those annotations, in order to formulate a single summary or multiple summaries to be returned to the AI summarization workflow tool 160 for rendering and review.

The GUI 200 further features the second input field 240 to allow the reviewer to select different types of output, such as a first output type 242 and a second output type 244. The first output type 242 may be directed to a certain summary format such as a summary that operates as content for a news article while the second output type 244 may be directed to an information delivery scheme such as a listing of bullet points or another format other than the first output type 242. As shown, the second input field 240 allows for manual selection of a particular form in which the summary 138 is to be provided. However, it is contemplated that selection of the output types 242/244 may be conducted automatically, based on settings associated with the reviewer submitting the document(s) 215 for summarization (e.g., user preferences or profile) and/or the content within the document(s) 215 that may be determined during the parsing operation. For instance, the AI summarization workflow tool 160 may conduct an analysis of the content of the submitted document(s) 215 based on selection of the output type 242/244 for the summary 138 for the document(s) 215.

The GUI 200 may further include a third input field 250, which allows the reviewer to control selection of certain processing elements 252, such as selection of a prescribed prompt layout (e.g., Prompt X) and/or which of the LLMs 132₁-132_{N} (e.g., LLM_3 132₃) to process the prompt 134 in generation of the summary 138 (or summaries) of the document(s) 215. For instance, as shown, the third input field 250 may include a text field 254 to include text notes from the user to select prompt/LLM usage or include specific instructions directed to the processing of the document(s) 215 such as inclusion or exclusion of certain words or phrases within the resultant summary returned by the LLM(s) 132.

The GUI 200 may further include a fourth input field 260, which allows for variability control in which the reviewer may control the degree of consistency in the generation of the summaries. For instance, selection of a “high” degree of variability 262 may cause the LLM(s) 132 to generate unique contextual information for each summary, despite the content of the document 215 selected to undergo summarization being identical. This provides greater variation between the phrases and/or sentence structure used by different summaries despite the source content (document 215) including identical or highly similar data. This may lessen reader suspicion that the summary 138 was computer generated. The selection of a “low” degree of variability 264 may cause the LLM(s) 132 to generate identical contextual information for summaries sourced by the same content (e.g., document 215) while selection of an “intermediate” degree of variability 266 may cause the LLM(s) 132 receiving content from the same source document to generate summaries having partial overlapping content.

The GUI 200 may further include a fifth input field 270, which allows for selection of a ranking scheme 272 for different types of annotations 135 identified and extracted from the document(s) 215. The ranking scheme 272 may be set according to a default scheme or may be sent by a user of the computing device 110 of FIG. 1 (or security administrator supporting the user of the computing device 110). The ranking scheme 272 may be relied upon by the AI summarization workflow tool 160 in the generation of the prompt 134 that prioritizes the use of certain content associated with higher ranked annotations in generating the summary 138 than content associated with lower ranked annotations. Additionally, or in the alternative, the ranking scheme 272 may be included as part of the prompt 134 and relied upon by the LLM(s) 132 in which certain annotations should be utilized more heavily in the creation of the summary 138 of FIG. 1 than others.

Referring now to FIG. 2B, an exemplary block diagram of an interactive screen display represented as a second GUI 280 associated with the AI summarization workflow tool 160 of FIG. 1 is shown. Similar to the first GUI 200 forth in FIG. 2A, the second GUI 280 is adapted to upload one or more documents 215₁-215_{M} for summarization; however, the second GUI 280 provides more user-based controls in the generation of the summary 138 by the generative AI logic 132 of FIG. 1.

More specifically, as shown, a first input field 285 for the second GUI 280 is adapted to allow for manual selection of different summary types as in FIG. 2A, but with greater granularity than offered by the second input field 240 for the first GUI 200. For example, as shown, the summary types may include a long narrative summary format 286, a short narrative summary format 287 or an itemized summary format 288. The long/short summary formats 286 and 287, when selected, may require compliance with a word count threshold (e.g., less than 150 words for short summary and more than 200 words for a long summary). For instance, the manual selection allows the reviewer to select the level of detail needed for the summary 138. The itemized summary format 288 may provide a bullet point format, in which the amount of detail may be greater than provided by the long/short summary formats 286/287, but the format is not conducive for usage as part of a news articles, etc.

In lieu of manual selection, the second GUI 280 may include a second input field 290 with multiple display elements. The second GUI 280 may be configured to automatically select the summary format based on user preferences 292 (e.g., content within a user profile accessible to the AI summarization workflow tool 160) or based on the content of the document 294 or a predicted targeted reader 296 of the generated summary 138 of the document 215₁ (determined by the generative AI logic). As an illustrative example, a second summary format (selection of the second display element 294) may be automatically selected as a medical research summary based on the content of the document 215₁ such as a scientific study. A third summary format (selection of the third display element 296) may be automatically selected as a news article based on the content of the document 215₁ involving newsworthy fact and/or the targeted reader is a newspaper editor.

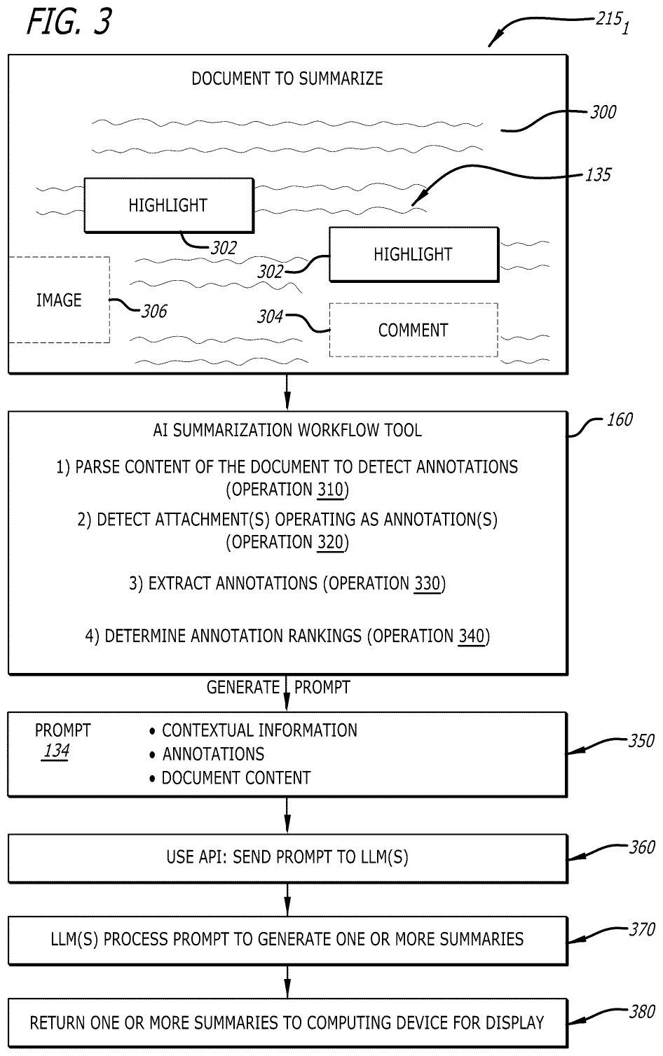

Referring now to FIG. 3, an exemplary flowchart of the operability of the AI summarization workflow tool 160 within a computing device 110 of FIG. 1 is shown. A document 215₁ is submitted for summarization, where the document 215₁ may include its original content 300 along with annotations 135. These annotations 135 may include text highlights 302, textual comments 304, or graphical annotations 306 placed on a surface of the document 215₁ such as notes added in the margin by a digital pen. Upon receipt of the document 215₁, the AI summarization workflow tool 160 performs a plurality of operations, including parsing content of the document 215₁ to detect the annotations 135 (operation 310) and/or a presence of an attachment to the document 215₁ that is operating as an annotation (operation 320). Thereafter, the AI summarization workflow tool 160 extracts the annotations 135 and inserts them into the prompt 134 (operations 330 & 350).

During or prior to insertion into the prompt 134, as an optional operation, each of the detected annotations 135 may be assigned a ranking (operation 340). The rankings of the annotations 135 may be relied upon by the LLM(s) 132 in generation of the content of the summary 138 (operation 350). According to one embodiment of the disclosure, the AI summarization workflow tool 160 may consider a number of factors in computing a ranking for each annotation. For example, a first factor may correspond to the type of annotation, where an annotation (of the annotations 135) with a particular annotation type may be assigned with a greater score (ranking) than another annotation type. The higher ranking identifies that the content associated with that annotation may have a greater likelihood of being used as content forming the summary 138 than a lower ranked annotation. As another example, a second factor may correspond to the placement of the annotation within the document 215₁, where locations of highlights within certain sections of the summary 138 (e.g., title, opening paragraph of the body of the document 215₁, etc.) may be utilized in assigning of the ranking to the annotation. The rankings may be included as a parameter with each annotation or as a ranking hierarchy in which the LLM(s) 132 can assign a ranking based on the type of annotation included in the prompt.

Besides annotation type and/or placement, another factor may include the subtype, namely a category for that particular annotation or a particular naming convention may be used. Herein, different subtypes may exist for a particular annotation and these subtypes may be assigned different rankings. For example, different highlight colors may be assigned different ranks for a highlight annotation.

After generation, the prompt 134 is sent by the AI summarization workflow tool 160 to the cloud services 130 via an Application Programming Interface (API) for receipt by the LLM(s) 132 (operation 360). The LLM(s) 132 processes the prompt 134 and provides the AI summarization workflow tool 160 with the LLM-generated summary 138, which may be stored in a local data store of the computing device 110 or within an external data store (operations 370 and 380). The summary 138 may be rendered by a GUI produced by the GUI generation logic 170 (see FIG. 1) to allow the user to review the content of the summary 138 accordingly. As an alternative feature, the AI summarization workflow tool 160 may be configured to generate a GUI that allows for selection of different versions or sections of the summary 138 for resubmission to the LLM(s) 132 that, in turn, causes the LLM(s) 132 to generate a secondary summary or summaries for evaluation by the user as illustrated in FIGS. 6C & 9.

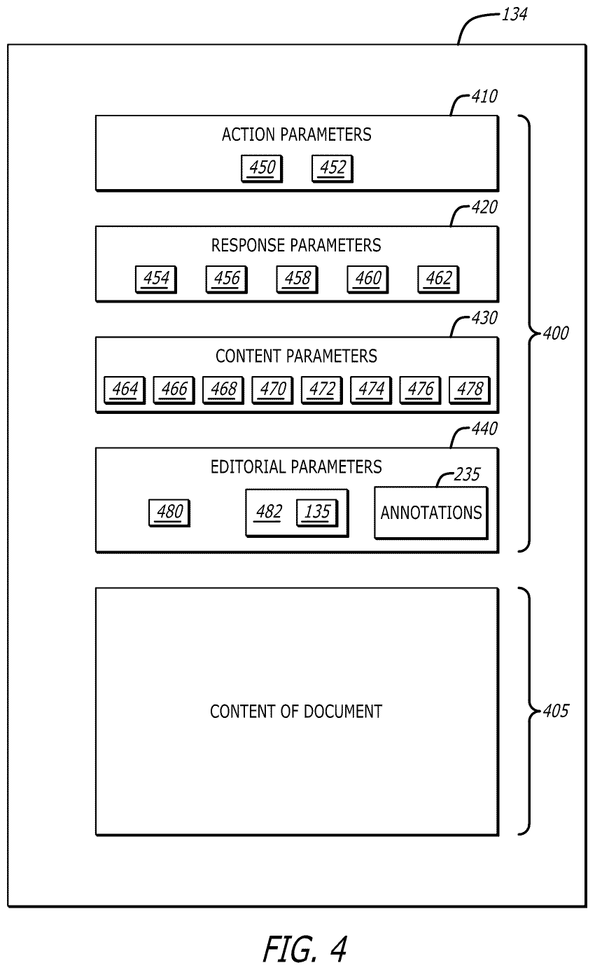

Referring now to FIG. 4, an exemplary block diagram of the prompt 134 created by the AI summarization workflow tool 160 of FIG. 1 is shown. Generated and submitted to the LLM(s) 132, this customized prompt 134 includes a plurality of different parameters 400 inclusive of the annotations 135 extracted from the document 215₁, along with content 405 associated with the original document 215₁. The parameters 400 associated with the prompt 134 may be directed to (A) intended or desired actions associated with submission of the prompt 134 (hereinafter, “action parameters” 410); (B) characteristics associated with the response (summary) to the prompt 134 (hereinafter, “response parameters” 420); (C) content restrictions and/or requirements associated with the summary (hereinafter, “content parameters” 430); and (D) editorial controls such as stylistic controls, annotation, etc. (hereinafter, “editorial parameters” 440).

As further set forth in Table A below, the action parameters 410 may feature information including, but not limited or restricted to any or all of the following: (1) purpose of the output content 450; and (2) audience characteristics (context of content) 452. The response parameters 420 may feature information including, but not limited or restricted to any or all of the following: (3) structural guidelines 454; (4) response length 456; (5) statistical representation 458; (6) justification requirements 460; and (7) technical integration formatting requirements 462.

The content parameters 430 may feature information including, but not limited or restricted to any or all of the following: (8) language and style guidelines 464; (9) non-redundancy and continuity 466; (10) abbreviation and acronym usage 468; (11) originality and plagiarism avoidance 470; (12) factual adherence 472; (13) example phrasing format 474; (14) drug naming conventions 476; and (15) exclusion of irrelevant sections 478. The editorial parameters 440 may feature information including, but not limited or restricted to any or all of the following: (16) editorial style variety 480 and (17) additional information as hints/suggestions 482.

TABLE A

| | |
|---|---|
| Purpose of the Output Content | Example: Identifies a purpose for the |
| 450 | summary, such as a summary of medical |
| | studies for a large journalistic organization |
| | focusing on content for healthcare |
| | professionals. |
| Audience Characteristics | Example: Identifies the primary audience |
| (Context of Content) 452 | (reader) for the summary, such as doctors |
| | and healthcare professionals requiring |
| | concise, accurate medical summaries. |
| Structural Guidelines 454 | Example: Identifies general structural |
| | attributes for the summary, such as long |
| | title (exceeding a prescribed number of |
| | characters or words), short title, etc., each |
| | with specific instructions on content and |
| | formatting. |
| Response length 456 | Example: Identifies general length of the |
| | summary along with general structural |
| | attribute thresholds such as the title should |
| | be 100-120 characters, conveying the key |
| | findings of the study while being |
| | intriguing and professional, and/or |
| | including 3-5 bullet points in a summary |
| | section if a method of operation is |
| | described. |
| Statistical Representation 458 | Example: Identifies and includes |
| | quantitative data that may be used in the |
| | summary. |
| Justification Requirement 460 | Example: After each section of the |
| | summary, an explanation why the |
| | summary is worded appropriately and how |
| | it adheres to the guidelines. |
| Technical Integration | Example: Present the final output in a |
| Formatting Requirement 462 | specified format (JSON) with each section |
| | clearly delineated. |
| Language and Style | Example: Identifies language exclusions |
| Guidelines 464 | and the desired tone of the summary, such |
| | as (i) avoiding medical jargon while |
| | adhering to a list of permissible |
| | abbreviations/acronyms and (ii) retaining |
| | a neutral tone without being overly |
| | positive of medical findings. |
| Non-redundancy and | Example: Information in each section |
| Continuity 466 | should be distinct yet maintain continuity, |
| | avoiding redundancy while reinforcing |
| | key concepts. |
| Abbreviation and Acronym | Example: Use the full term/abbreviation |
| Usage 468 | mapping. |
| Originality and Plagiarism | Example: Identifies strict rules to avoid |
| Avoidance 470 | usage of exact verbatim from a document |
| | without identification of reliance on that |
| | document. |
| Factual Adherence 472 | Example: Identifies strict rules to adhere |
| | to the information provided in the source |
| | document without making inferences or |
| | assumptions. |
| Example phrasing format 474 | Example: Follow the example format for |
| | the source section. |
| Drug Naming Conventions | Example: Write generic drug names in the |
| 476 | following format unless they appear at the |
| | beginning of a sentence or a title. |
| Exclusion of irrelevant | Example: Identifies sections from the |
| sections 478 | analysis without guidelines or |
| | recommendation. |
| Editorial Style Variety 480 | Example: Create titles in various editorial |
| | styles such as Scientific, Interrogative, |
| | Intriguing, Humorous, etc. for editor |
| | selection. |
| Additional information as | Example: Includes annotations (e.g., |
| Hints/Suggestions 482 | highlights, comments, graphical images, |
| | etc.) to consider and potentially |
| | incorporate into the summary. |

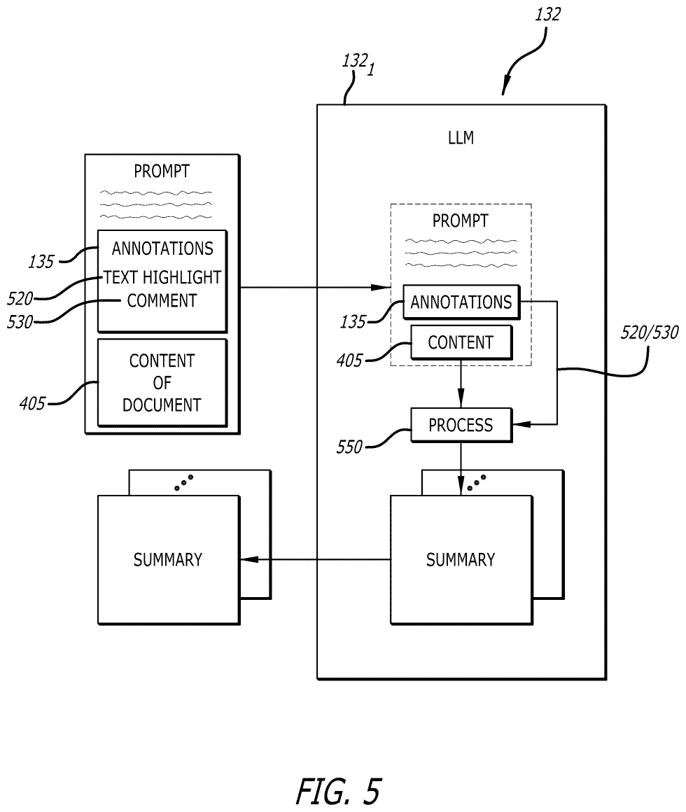

Referring to FIG. 5, an exemplary block diagram of the data exchange between the AI summarization workflow tool 160 and the generative AI logic 132 of FIG. 1 is shown. Including content 405 associated with the submitted document 215₁ along with the annotations 135, the prompt 134 is provided to the generative AI logic 132, such as a first LLM 132₁. The first LLM 132₁ is configured to evaluate the content 405 and the annotations 135, all of which may be relied by the LLM's process task 550 in the generation of (i) the summary 138 returned to the computing device operating as the source of the prompt 134 or (ii) multiple summaries that are concurrently generated with different writing styles or toward different recipients (readers) based on one or more prompts from the computing device (including prompt 134) and concurrently displayed similar to the interactive display as shown in FIG. 6C (different summaries adjacent to each other as outputs from different LLMs). As an optional feature, according to one embodiment of the disclosure, the annotations 135 may be ranked based on annotation type, where the content associated with higher ranked annotations are more likely utilized in producing the summary 138 of the document 215₁ than lesser ranked annotations.

As an illustrative example, the annotations 135 may include at least one text highlight 520 and one or more text-inserted comment 530 within the content 405. For this example, the text-inserted comment 530 may be assigned a rank, in order of importance, higher than any of the text highlight 520. As a result, the content associated with the text-inserted comment 530 will have more influence (e.g., a higher probability of usage, etc.) in the generation of the content for the summary 138 than the text highlight 520. Alternatively, the text-inserted comment 530 may be assigned a lower rank of importance than any of the text highlights 520. As a result, the content associated with the text highlight 520 will have more influence in generation of the content of the summary 138 than the text-inserted comment 530. Moreover, certain highlight colors may have assigned different rankings, in which a text highlight of a first highlight color will be assigned a higher ranking (score), and a greater probability of influencing the content of the summary 138, than a text highlight of a second highlight color.

Referring now to FIG. 6A, an exemplary block diagram of operations conducted by the AI summarization workflow tool 160 configured with feedback logic 600 to further refine the resultant summary 138 based on feedback metrics 610 is shown. Including the content 405 of the submitted document 215₁ along with the annotations 135, the prompt 134 is provided to the generative AI logic 132, such as the first LLM 132₁. The first LLM 132₁ is configured to utilize the content 405 and the annotations 135, both of which are relied upon in the generation of the summary 138 returned to the source that provided the prompt 134 (e.g., computing device 110).

According to this embodiment of the disclosure, the AI summarization workflow tool 160 operates with the generative AI logic 132 to render the summary 138. The summary 138 may feature different sections 620, where the feedback logic 600 within the AI summarization workflow tool 160 may be configured to automatically analyze the summary 138 for compliance with intended focus, tone, writing style, and/or theme parameters. Additionally, or in the alternative, the summary 138 may be rendered and different sections of the summary 138 may be manually selected for further alteration and refinement by the generative AI logic 132.

A feedback response 630, inclusive the feedback metrics 610 (e.g., one or more sections of the summary 138 selected for further alteration, additional annotations associated made within the summary 138, reviewer identifier, etc.), is returned as a secondary (or resubmission) prompt 635 to the first LLM 132₁. The first LLM 132₁ is configured to further modify the summary 138 based on the feedback metrics 610 and generate a secondary summary 640 for automated analysis or manual analysis by the reviewer. The feedback metrics 610 (or a portion thereof), stored as part of a feedback data store 645 being a sub-component of the data store 180 of FIG. 1 according to one embodiment, may be adapted to assist training and/or adjust operations of the first LLM 132₁ to better capture the focus, tone, writing style, and/or theme representative of the reviewer.

Referring to FIG. 6B, an exemplary block diagram of a third graphical user interface (GUI) 650 associated with the AI summarization workflow tool 160 with the feedback logic 600 of FIG. 6A is shown. Herein, the third GUI 650 is arranged for selection of a source document 665 to be provided to the generative AI logic 132 from which the summary 138 is generated. The third GUI 650 is further configured to collect the feedback metrics 610 of FIG. 6A, which are returned to the generative AI logic 132 for further revision as the secondary summary 640 of FIG. 6A. The third GUI 650 includes a source document display region 660, documents review display region 662, and a feedback display region 664. These display regions 660, 662 and 664 may allow for manual selection of sections within a single summary or different summaries.

The source document display region 660 is configured to enable a reviewer to select the source document 665 for visual display within the documents review display region 662 or select a Uniform Resource Locator (URL) link to the source document 665 that, once selected, would cause a new browser window to launch to visually display contents of the source document 665 within the region 662. The source document 665 may correspond to a document selected to be summarized (e.g., document 215₁ of FIG. 2A). The source document 665 may or may not include annotations. Additionally, or in the alternative, the source document 665 may correspond to the summary 138 of FIG. 1 previously generated from an annotated document by the generative AI logic 132 for further revision.

The documents review display region 662 is configured to display a source document and its summary such as, for example, the source document 665 (with highlighted sections utilized for the summary) identified in the source document display region 660 along with a summary 667 for that document. This display layout enables the reviewer to confirm usage of certain annotations within the summary 667 and also enables the reviewer to select or enter feedback information 670 associated with the summary 667 within the feedback display region 664. The feedback information 670 may identify the quality of the summary 676 (e.g., great, good, bad) along with selectable display elements 678 identifying improvements that could be needed for the summary 667 (e.g., more concise, reduced sentence size, etc.). The feedback information 670 may be included as at least part of the feedback metrics 610 of FIG. 6A.

As further shown in FIG. 6B, the summary 667 generated by the generative AI logic 132 and displayed within the documents review display region 662 may be segmented into multiple sections 672₁-672_{M} (M>1). Each of these sections 672₁-672_{M} features a display element 674₁-674_{M}, which allows the user to select sections of the summary to be further modified or to remain intact without further modification. The selected sections (e.g., 672₂) may be provided as part of the feedback metrics 610 to the generative AI logic 132.

As another example, as shown in FIG. 6C, an exemplary block diagram of a fourth graphical user interface (GUI) 675 associated with the AI summarization workflow tool 160 with the feedback logic 600 of FIG. 6A is shown. Herein, the fourth GUI 675 is configured to render multiple summary versions produced from the source document 665, where these summary versions can be generated sequentially after feedback or generated concurrently based on content within the prompt 134. As an illustrative example, as shown, the documents review display region 662 of the fourth GUI 675 illustrates a first summary 680 and the second summary 685 may be generated by the generative AI logic 132, where the first summary 680 is segmented into multiple sections 682₁-682_{M} (M>1) and the second summary 685 is segmented into multiple sections 687₁-687_{M}, respectively. Selectable display elements 684₁-684_{M} are positioned at corresponding sections 682₁-682_{M} of the first summary 680 and other selectable display elements 688₁-688_{M} are positioned at corresponding sections 687₁-687_{M} of the second summary 685. This allows the user to select sections of different summaries to identify sections with language and description preferred by the reviewer, where the content of the selected sections may be submitted to the generative AI logic 132 of FIG. 1 to produce a collective summary. The selection may be mutually exclusive as only one display element associated with the title 684₁ or 688₁ may be selected, one display element associated with the background section 684₂ or 688₂, and the like.

As an illustrative example, as shown, a revised summary may be formed by a collection of the selected sections from different summaries, such as sections 682₁ and 682₃ of the first summary 680 and sections 687₂ and 687₄ of the second summary 685. These selected sections 682₁, 682₃, 687₂ and 687₄ may be provided as part of the feedback metrics 610 to the generative AI logic 132, and the content of these selected sections 682₁, 682₃, 687₂ and 687₄ are used to generate of one or more revised summaries for display.

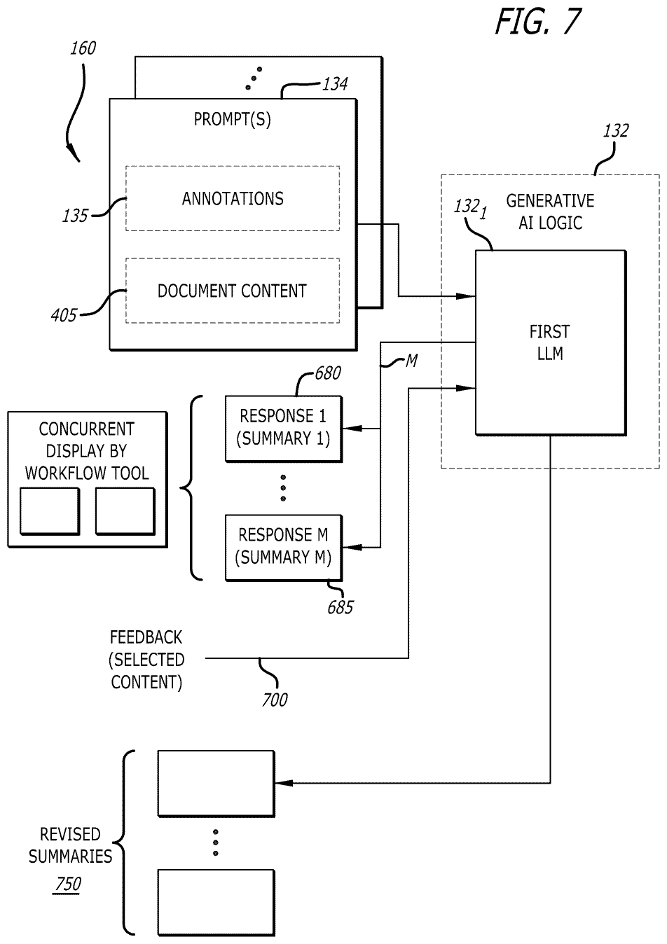

Referring to FIG. 7, an exemplary block diagram of the operations of the AI summarization workflow tool 160 of FIG. 1 operating with the generative AI logic 132 is shown, where the multiple summaries 680 and 685 with stylistic and thematic differences are generated and feedback metrics 610 associated with these summaries 680 and 685 are returned for iterative summary generation as described above.

Including content 405 associated with the submitted document 215₁ along with the annotations 135, the prompt (or prompts) 134 is provided to the generative AI logic 132, such as a first LLM 132₁. The first LLM 132₁ is configured to evaluate the content 405 and the annotations 135, both of which are relied upon to generate multiple summaries 680 and 685 as shown in FIG. 6C. The summaries 680 and 685 may be provided to a computing device supplying the prompt 134 or a different destination.

The first summary 680 and the second summary 685 are concurrently displayed by the AI summarization tool 160 as shown in FIG. 6C. Certain sections 682₁, 682₃, 687₂ and 687₄ within these summaries 680 and 685 may be selected as signifying content drafted in a manner acceptable to the reviewer. The AI summarization tool 160 may be further configured, automatically or manually, to return feedback associated with the section selection by the reviewer. More specifically, the selection of different sections within different summaries 680 and 685 may cause a feedback message 700, inclusive of feedback metrics 610, to be generated, where the feedback message 700 identifies the selected (or non-selected) sections of the summaries 680 and 685. In response to the feedback message 700, the generative AI logic 132 is configured to generate one or more revised (secondary) summaries 750.

The generative AI logic 132 may be configured to generate the one or more revised summaries 750 based on any of a number of different analysis schemes. For instance, according to one analysis scheme, the generative AI logic 132 may be configured to generate a revised summary that is formed by the selected sections. According to another analysis scheme, the generative AI logic 132 may be configured to generate a plurality of revised summaries that are formed by revising the selected sections in accordance the tone and/or writing style exhibited by certain selected sections. For example, a first revised summary may include the selected sections revised according to the tone and writing style found in the first selected section (e.g., section 682₁). The first revised summary may include the selected sections revised according to the tone and writing style found in the second selected section (e.g., section 687₂). It is contemplated that some selected sections with a revised summary may be significantly modified while other sections may have little to no modification.

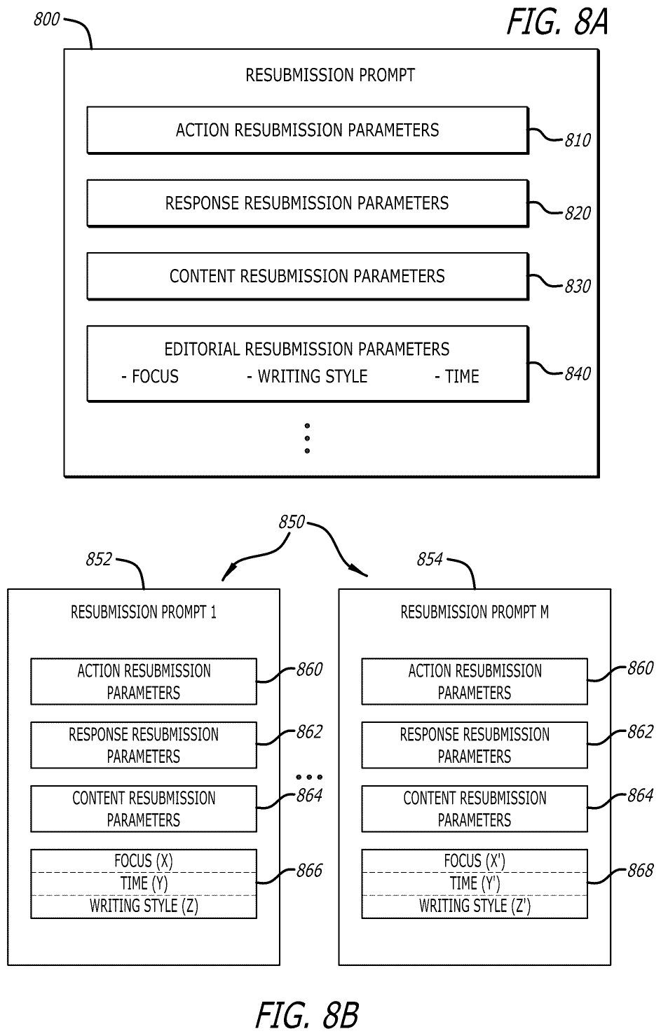

Referring now to FIG. 8A, an exemplary block diagram of a resubmission prompt 800, representative of the resubmission prompt 635 of FIG. 6A and generated by the AI summarization workflow tool 160 in accordance with the operations of FIG. 7, is shown. Herein, according to one illustrative embodiment, the resubmission prompt 800 includes four different types of parameters; namely, action resubmission parameters 810, response resubmission parameters 820, content resubmission parameters 830, and editorial resubmission parameters 840. The action resubmission parameters 810 are adapted to identify the actions to be conducted in response to the resubmission prompt 800. In general, the actions may include the regeneration of one or more summaries based on the content included in the other resubmission parameters 820, 830 and 840. As in the action parameters associated with a prompt, the action parameters 810 are designed to identify the purpose of the output content as well as the audience to which the revised summary is directed.

The response resubmission parameters 820 may be adapted to provide information associated with the structure of the response for the resubmission prompt 800. For instance, the response resubmission parameters 820 may be identical or substantially equivalent in operation to the response parameters that are used to generate the summaries upon which the resubmission prompt 800 was created. In other situations, the response resubmission parameters 820 may be adapted to provide a revised summary, which may be configured to identify the original content from the additional content (e.g., additional content represented in a track-change format or in another font type that enables changes made to the revised summary or a section of the revised summary to be more easily identifiable).

The content resubmission parameters 830 may be adapted to identify the particular content associated with the revised summary or summaries being generated in response to the resubmission prompt 800. The content may identify certain restrictions or certain preferences that were previously provided in the original prompt such as the use of abbreviations, plagiarism avoidance, factual adherence, and other response parameters.

The editorial resubmission parameters 840 are adapted to identify the editorial parameters that may be identified by selection in a GUI such as a certain type of tone or a certain theme or writing style that is being used as well as durability control and annotation rankings in the event that the resubmission prompt 800 includes annotations made to the summary or summaries previously evaluated.

Referring now to FIG. 8B, an exemplary block diagram of multiple resubmission prompts 850 generated by the AI summarization workflow tool 160 in accordance with the operations of FIGS. 7-8A is shown. Herein, a first resubmission prompt 852 includes a set of action resubmission parameters 860, a set of response resubmission parameters 862, a set of content resubmission parameters 864, and a set of editorial resubmission parameters 866, as described above. In addition, a second resubmission prompt 854 may be generated with the same action resubmission parameters 860, response resubmission parameters 862, and content resubmission parameters 864. However, the editorial resubmission parameters 868 may be different from the set of editorial resubmission parameters 866, where the editorial resubmission parameters 868 may cause the generative AI logic to generate a second revised summary with a different writing style or writing tone from the first resubmission prompt 852. The different editorial parameters 868 cause the generative AI logic 132 to generate different conveyances of the content in which the reviewer may accept the revised summary or cause another edited change based on preferences of the reviewer towards a slightly different focus, tone or writing style that offered by the revised summary.

Referring to FIG. 9, an exemplary embodiment of iterative operations performed in accordance with (i) selection of different sections of multiple summaries 680 and 685 of FIG. 6C displayed by the GUI 675 and (ii) generation of the one or more revised summaries 750 of FIG. 7 is shown. Herein, the GUI 675 illustrates the different sections 682₁-682_{M} of the first summary 680 while concurrently displaying sections 687₁-687_{M} of the second summary 685. The sections 682₁-682_{M} of the first summary 680 include display elements 684₁-684_{M} while the sections 687₁-687_{M} of the second summary 685 include display elements 688₁-688_{M}.

This GUI 675 generates and displays the multiple summaries 680 and 685 concurrently and the generative AI logic 132 is configured to transform the selected sections into the resubmission prompt 800, which is provided to the generative AI logic 132 to create one or more revised summaries summary 910 (e.g., first revised summary 920 and second revised summary 930) for display as GUI 940. The GUI 940 may display (i) the first revised summary 920 formed by a plurality of sections 922₁-922_{M} along with corresponding display elements 924₁-924_{M} and (ii) the second revised summary 930 formed by a plurality of sections 932₁-932_{M} along with corresponding display elements 934₁-934_{M}. As before, selection of sections directed to a single revised summary 920 or 930 (e.g., sections 922₁-922_{M} or sections 932₁-932_{M}) and activation (selection) of a display element 950 may cause completion of the summary generation. Alternatively, selection of sections from different revised summaries 920 and 930 and activation of the display element 950 may cause the AI summarization workflow tool 160 to generate an additional resubmission prompt to provide to the generative AI logic to prompt re-creation of another revised summary or summaries.

In the foregoing description, the invention is described with reference to specific exemplary embodiments thereof. It will, however, be evident that various modifications and changes may be made thereto without departing from the broader spirit and scope of the invention as set forth in the appended claims.

What is claimed is:

1. A computing device, comprising:
one or more processors; and
a non-transitory storage medium communicatively coupled to the one or more processors, the non-transitory storage medium comprises an artificial intelligence (AI) summarization workflow software tool configured to identify and extract annotations associated with a document, generate a prompt including the annotations and content associated with the document, and output the prompt to generative AI logic configured to generate at least a summary of the document based on the annotations.

2. The computing device of claim 1, wherein the annotations include highlighted text or image within the document.

3. The computing device of claim 1, wherein the annotations include a comment inserted into and adjacent to selected text or images within the document.

4. The computing device of claim 1, wherein the annotations include graphical images representing notes placed adjacent to text within the document or notes placed within margins of the document.

5. The computing device of claim 1, wherein the generative AI logic includes one or more large language models.

6. The computing device of claim 5, wherein the non-transitory storage medium further comprises graphic user interface (GUI) generation logic configured to generate an interactive screen display for concurrently rendering one or more summaries, including the summary, produced by the one or more large language models based on analysis of the annotations included in the prompt.

7. The computing device of claim 6, wherein each of the one or more summaries is generated by the one or more large language models with a different writing style.

8. The computing device of claim 1, wherein the AI summarization workflow software tool is further configured to compute and assign a ranking for each annotation of the annotations based on a prescribed level of importance or usefulness of each annotation in creation of the summary.

9. The computing device of claim 8, wherein a first annotation of the annotations constitutes a first type of annotation that is assigned a higher ranking than a second type of annotation or the first type of annotation of a first subtype is assigned a higher ranking than the first type of annotation of a second subtype.

10. The computing device of claim 9, wherein the first type of annotation corresponds to a comment and a second type of annotation corresponds to a highlight.

11. The computing device of claim 9, wherein the first type of annotation of the first subtype corresponds to a first highlight of text within the document with a first color highlight and the second type of annotation of the second subtype corresponds to a second highlight of text within the document with a second color highlight different than the first color highlight.

12. A non-transitory storage medium including software, operating as part of a computing device, conducting analytics on a document to assist generative artificial intelligence (AI) logic configured to generate and return at least a summary of the document in response to submission of the document, comprising:
a first software module configured, upon execution, to identify and extract annotations associated with the document, generate a prompt including the annotations and content associated with the document, and output the prompt for submission to the generative AI logic to cause generation and return of at least the summary of the document, wherein the summary is based at least in part on the annotations; and
a second software module configured to generate, upon execution, an interactive screen display for concurrently rendering one or more summaries, including at least the summary, produced by the generative AI logic based on analysis of the annotations included in the prompt.

13. The non-transitory storage medium of claim 12, wherein the generative AI logic includes one or more large language models deployed as a cloud resource or as part of an on-premises hosted service.

14. The non-transitory storage medium of claim 12, wherein the annotations identified and extracted by the first software module include one or more of (i) highlighted text within the document, (iii) a comment inserted into and adjacent to selected text or images within the document, or (iii) graphical images representing notes placed within margins of the document.

15. The non-transitory storage medium of claim 12, wherein each of the one or more summaries is generated with a different writing style.

16. The non-transitory storage medium of claim 12, wherein the first software module is further configured to compute and assign a ranking for each annotation of the annotations based on a prescribed level of importance or usefulness of each annotation in creation of at least the summary.

17. The non-transitory storage medium of claim 16, wherein a first annotation of the annotations constitutes a first type of annotation that is assigned a higher ranking than a second type of annotation and the first type of annotation of a first subtype is assigned a higher ranking than the first type of annotation of a second subtype.

18. The non-transitory storage medium of claim 17, wherein (1) the first type of annotation corresponds to a comment and a second type of annotation corresponds to a highlight or (2) the first type of annotation of the first subtype corresponds to a first highlight of text within the document with a first color highlight and the second type of annotation of the second subtype corresponds to a second highlight of text with a second color highlight different than the first color highlight.

19. A generative artificial intelligence (AI) summarization platform comprising:
a network resource including one or more large language models; and
a computing device communicatively coupled to the network resource via a network, the computing device comprises
one or more processors, and
a non-transitory storage medium communicatively coupled to the one or more processors, the non-transitory storage medium includes an artificial intelligence (AI) summarization workflow software tool configured to identify and extract annotations associated with a document, generate a prompt including the annotations and content associated with the document, and output the prompt to the one or more large language models configured to generate at least a summary of the document based on the annotations.

20. The generative AI summarization platform of claim 19, wherein the annotations include any of: (i) highlighted text or a highlighted image within the document, (ii) a comment inserted into and adjacent to selected text or images within the document, or a graphical image representing a note placed adjacent to text within the document.
